(19) United States
(12) Patent Application Publication
(10) Pub. No.: US 2008/0026253 A1
(43) Pub. Date: Jan. 31, 2008

(54) CPP TYPE GIANT MAGNETO-RESISTANCE ELEMENT AND MAGNETIC SENSOR

(75) Inventors: Shinji Yuasa, Ibaraki (JP); Akio Fukushima, Ibaraki (JP)

Correspondence Address: SUGHRUE MION, PLLC, 2100 PENNSYLVANIA AVENUE, N.W., SUITE 800, WASHINGTON, DC, 20037, US

(73) Assignee: NATIONAL INSTITUTE OF ADVANCED INDUSTRIAL SCIENCE AND TECHNOLOGY, Tokyo (JP)

(21) Appl. No.: 11/688,570

(22) Filed: Mar. 20, 2007

(30) Foreign Application Priority Data
Jul. 27, 2006 (JP) 2006-204713

(51) Int. Cl. G11B 5/39

(52) U.S. Cl. 428/811

(57) ABSTRACT

Provided are a CCP (current confined path)-CPP (current-perpendicular-to-plane) type giant magneto-resistance (GMR) element having a giant magneto-resistance ratio in a low resistance region (a region of not more than 1 ohm per square micrometer) and a magnetic sensor using this GMR element. The CCP-CPP type GMR element A has a laminated structure of an anti-ferromagnetic layer, a magnetization pinned layer, an intermediate layer and a magnetization free layer, and is formed to have a construction in which a current flows perpendicularly to a film plane. By using an ultrathin magnesium oxide layer having micropores that is preferentially oriented in the (001) direction as the intermediate layer, the magneto-resistance ratio is enhanced, because a current flowing from the magnetization free layer to the magnetization pinned layer (or in the opposite direction) is confined by the metal in the micropores.

### BACKGROUND

1. Technical Field

Aspects of the present invention relate to a current perpendicular to plane (CPP) type giant magneto-resistance element having a construction in which a sense current flows in a direction perpendicular to the film plane, and a magnetic sensor having a CPP type giant magneto-resistance element.

2. Related Art

A magneto-resistance element is an electronic element that includes a magnetization pinned layer, an intermediate layer and a magnetization free layer and having a resistance value that varies depending on whether the directions of magnetization of the magnetization pinned layer and the magnetization free layer are parallel or antiparallel. In a related art magneto-resistance element, the thickness of each of the above-described three layers ranges from several tens of nanometers (nm) to several nanometers. Because electrons with upward spin and electrons with downward spin have different scatterings at an interface between the magnetization pinned layer (or the magnetization free layer) and the intermediate layer depending on the directions of the magnetization of the magnetization pinned layer and the magnetization free layer, magneto-resistance (the phenomenon defined by a resistance value that changes according to an external magnetic field) occurs. Hereinafter, magneto-resistance will be abbreviated as MR, and the magneto-resistance ratio will be written as the MR ratio.

In a related art proposed giant magneto-resistance element (hereinafter “GMR element”), a nonmagnetic metal is used as the intermediate layer, and a tunnel magneto-resistance element (hereinafter called a “TMR element”) includes an insulator used as the intermediate layer. The related art GMR element and the related art TMR element have already been brought into commercialization for use in magnetic sensors (used as magnetic heads of hard disks and the like).

The related art GMR element is of a type called the CIP (current-in-plane)-GMR element in which a current is caused to flow parallel to the film plane for the three layers of a magnetization pinned layer, an intermediate layer and a magnetization free layer. In this related art GMR element, the MR ratio is essentially lower than a theoretical value because unscattered current components are present at some ratios on those film planes of the magnetization pinned layer, the magnetization free layer, and the intermediate layer.

On the other hand, in a related art proposed CPP (current-perpendicular-to-plane)-GMR element, a current is caused to flow perpendicularly to the film plane. In an element of this type, all currents pass through an interface between the magnetization pinned layer (the magnetization free layer) and the intermediate layer. Thus, the MR ratio is essentially higher than in the CIP-GMR element. This has also been ascertained experimentally.

With respect to such related art CPP-GMR elements, it has been proposed in the related art to have a spin valve structure applied to improve magnetic properties (refer to, for example, Japanese Patent Laid-Open No. 2002-124721 “SPIN VALVE STRUCTURE AND ITS FORMATION METHOD AS WELL AS REPRODUCING HEAD AND ITS MANUFACTURING METHOD”), in which the MW ratio is improved by using a material of high resistance value in a hard bias layer (a magnetic stabilized layer) of a CPP-GMR element (refer to, for example, Japanese Patent Laid-Open No. 2002-353536 “GIANT MAGNETORESISTIVE ELEMENT AND HUGE MAGNETORESISTIVE HEAD”), those in which the MR ratio is improved by interposing a thin film in an interface between an intermediate layer and a magnetization pinned layer (magnetization free layer) (refer to, for example, Japanese Patent Laid-Open No. 2004-6589 “MAGNETO-RESISTANCE EFFECT ELEMENT; MAGNETIC BEAD, AND MAGNETIC REPRODUCING DEVICE”), and those in which the MR ratio is improved by using an anti-ferromagnetic multilayer film including a ruthenium intermediate layer in a magnetization free layer (refer to, for example, Japanese Patent Laid-Open No. 2004-289100 “CPP TYPE GIANT MAGNETORESISTIVE ELEMENT, AND MAGNETIC COMPONENT AND MAGNETIC DEVICE USING IT”).

For the related art TMR element, an element in which aluminum oxide or magnesium oxide is used as a barrier (an intermediate layer) has hitherto been proposed and researched and developed for commercialization. In particular, a related art TMR element in which magnesium oxide is used as a barrier (hereinafter, called an “MgO-TMR element”), has unprecedented huge MR ratios (not less than 400% at room temperature). In addition, the MR ratio does not decrease much even when resistance decreases (refer to a group of papers on MgO-TMR elements having high M ratios: 1) S. Yuasa et al., Nature Mater. Vol. 3 (2004), pp. 868; 2) S. Yuasa et al, Appl. Phys. Lett. Vol. 87 (2005), pp. 222508; 3) S. S. Parkin et al., Nature Mater. Vol. 3 (2004), pp. 862; and 4) D. Djayaprawira et al, Appl. Phys. Lett. Vol. 86 (2005), pp. 092502; and a group of papers on MgO-TMR elements having low RA values: 1) K. Tsunekawa et al., Appl. Phys. Lett. Vol. 87 (2005), pp. 072503; and 2) S. Ikeda et al., Jpn. J. Appl. Phys. Vol. 44 (2005), pp. L1442.

When related art applications to magnetic sensors are considered, one technique is related to the read head of a hard disk. With advances in the recording density of a hard disk medium, magnetic recording bits have become increasingly small, and it is necessary to reduce also the size of a magnetic sensor part accordingly. Furthermore, with an increase in the recording density, higher data readout speeds will become required. For the electrical circuit design of higher data read-out speed, it becomes important to ensure electrical matching (impedance matching) between a magnetic sensor part and a readout circuit (a sense amplifier part) and for example, several tens of ohms are required as actual magnetic sensor resistance. That is, compatibility between a low value of resistance per area and a high MR ratio is required in applications to high-density recording, high-speed readout hard disks. Hereinafter resistance per area is abbreviated as RA, and the unit area is an area of one square micrometer in accepted practice. Furthermore, in order for the surface recording density of a hard disk to be increased to not less than 1 Tbytes/square inch, thereby to realize high-speed information readout of not less than 2 GHz, it is desirable to develop a CPP type MR element having a high MR ratio in a region of RA value of lower than 1Ω per square micrometer.

A high-density hard disk having a surface recording density of 200 Gbytes/square inch may require CPP type MR elements (TMR elements or CPP-GMR elements) having the characteristics that the RA value not more than 4 Ω/square micrometer and the M ratio not less than 20%. In addition, a high-density hard disk having a surface recording density of 500 Gbytes/square inch may require a read-head with a CPP type MR elements having the characteristics that the RA valve of not more than 1 Ω/square micrometer and that the MR ratio is not less than 20%.

In the related art development of CPP type MR elements intended for use in the read heads of hard disks, there have hitherto been adopted (1) a technique that involves increasing the M ratio, with the RA value kept at a low value, by using a CPP-GMR element and (2) a technique that involves decreasing the RA value by decreasing a thickness of an intermediate layer, with a high MR ratio kept, by using a TMR element.

In the above-described related art technique (1), there is no problem in the RA value, but it is difficult to increase the MR ratio. For example, the MR ratios in a spin valve type CPP-GMR element that have hitherto been reported are several percents at most and it can be said that these values are non-commercializiable. Although in the CPP-GMR element described in Japanese Patent Laid-Open No. 2004-289100, values of approximately 8% are reported as larger values for MR ratio, it cannot be said that they are sufficient values as values required in the read-head of high-density hard disks as described above.

Incidentally, in the above-described related art technique (2), a case where aluminum oxide is used as a barrier (an intermediate layer in an MR element) poses the problem that the MR ratio becomes substantially small in a region where the RA value is not more than several ohms/square micrometer. Furthermore, this technique has the problem that even when magnesium oxide is used as a barrier, the MR ratio decreases abruptly in a region where the RA value is not more than 1 Ω/square micrometer.

An aspect of the present invention includes an MR element having characteristics required by a magnetic sensor suitable for ultrahigh-density magnetic recording. More particularly, an aspect includes an MR element that has low area resistance values (not more than 1 Ω/square micrometer in terms of the RA value) and can realize high M ratios (not less than 20%), and a magnetic sensor (for example, a magnetic head for hard disk) in which this MR element is used.

### SUMMARY OF THE INVENTION

Aspects of the present invention include a CCP type MR element in which an ultrathin magnesium oxide (MgO) layer having a thickness of the order of three atomic layers is used as an intermediate layer. Although in this element a substantially thin MgO layer is used as the intermediate layer, from a measurement of the temperature dependency of the resistance value it became apparent that the element displays a metallic behavior (the resistance value is proportional to temperature). That is, it might be thought that the MR element is a kind of CPP-GMR element, and not a TMR element. From an observation of the shape of the ultrathin MgO layer it became apparent that micropores of several tens of nanometers are present in the film. The MgO layer may work to confine a current through the layer, and not as a tunnel barrier.

That is, according to an aspect of the present invention, in a CCP-CPP type MR element in which the RA value of the element is not lowered, a substantially thin MgO layer is used as the intermediate layer, pores are naturally (or intentionally) formed because of the extreme thinness, and metallic conduction is performed via the metal in the pores.

(Use of Ultrathin MgO Layer as Intermediate Layer)

A first MR element of the present invention has a first magnetic layer whose magnetization direction is fixed substantially in one direction (hereinafter called a magnetization pinned layer), a second magnetic layer whose magnetization direction varies according to external magnetic field (hereinafter called a magnetization free layer), and an intermediate layer formed between the first and second magnetic layers, are formed so that the element has a CPP shape (a current-perpendicular-to-plane shape in which a current flows perpendicularly to the film plane) and uses, as the intermediate layer, a single-crystal or polycrystalline MgO(001) layer, which has a thickness of not more than about 1.0 nanometer and whose crystalline is oriented in the (001) direction. By using the MgO(001) layer as the intermediate layer, the current confining effect is caused to come into effect due to the metal present in micropores that occurs naturally in the MgO(001) layer and, therefore, the MR ratio increases.

Because MgO is a cubic system (an NaCl type structure), the (001) plane, the (100) plane and the (010) plane are all equivalent. In this specification, the film plane is written in a manner unified with the (001) plane because a direction perpendicular to the film plane is the z axis. Similarly for the bcc structure, the (001) plane, the (100) plane and the (010) plane are all equivalent and, therefore, the film plane is written in a manner unified with the (001) plane. Also, in this specification, the bcc structure, which is the crystal structure of an electrode layer, refers to a body-centered cubic. More specifically, this bcc structure includes a bcc structure having no chemical order, what is called the A2 type structure, and a bcc structure having a chemical order, for example, the B2 type structure and the L21 structure, and includes these bcc structures in which crystal lattices are slightly strained.

In the above-described first MR element of the present invention, the thickness of the MgO(001) layer may be in the range of about 0.5 nanometer to about 0.7 nanometer and, furthermore, the thickness of the MgO (001) layer may be about 0.55 nanometer to about 0.65 nanometer (thicknesses equivalent to the thickness of the order of three MgO atomic layers). By using an ultrathin MgO layer having these thicknesses, it is possible to ensure that a low RA value and a high MR ratio are compatible with each other.

When an MR element is used as a magnetic sensor, variations may occur in the characteristics of the MR element as a magnetic sensor unless microscopically nonuniform structures (in the exemplary embodiment, micropores present in the MgO(001) layer) are sufficiently small compared to the size of the element. For example, because the size of an element required of a high-density magnetic head is on the order of several hundreds of nanometers square, in a case where the MR element is used in the above-described magnetic head, the size of the micropores must be sufficiently smaller than the required element size. Therefore, in the first MR element of the present invention, the diameter of the micropores present in the MgO(001) layer may be not more than about 50 nanometers.

(Use of Magnetization Pinned Layer of bcc (001) Structure)

The second MR element of the present invention is such that in the above-described first MR element, a single-crystal or polycrystalline ferromagnetic metal or a ferromagnetic metal alloy of a bcc (body-centered cubic) structure whose (001) plane will be oriented (hereinafter written as a ferromagnetic material of a bcc(001) structure) is used in a magnetization pinned layer formed on a first surface of the MgO(001) layer. By adopting this structure, the crystallizability and flatness of the MgO(001) layer are improved and the MR ratio increases further.

(Use of Magnetization Pinned Layer and Magnetization Free Layer, Both Having bcc (001) Structure)

The third MR element of the present invention is such that in the above-described first and second MR elements, a ferromagnetic material of a bcc(001) structure is used in the magnetization pinned layer formed on the first surface of the MgO(001) layer and a magnetization free layer formed on a second surface thereof. By adopting this structure, the crystallizability and flatness of the MgO(001) layer may be improved and the MR ratio may increase.

(Δ1 Bloch State)

In general, crystalline materials have the property that the transmission coefficient for an electron band varies depending on crystal orientations. For this reason, by using a crystalline material in the intermediate layer and selecting an appropriate crystal orientation in the M element, it is possible to cause only electrons of a band with a high spin polarization rate to be transmitted, with the result that the M ratio can be increased. This effect is called the spin filter effect. It has been demonstrated by the present inventors that the MgO(001) layer can cause only electrons which are in the Δ1 Bloch state and have an upward spin to pass by a combination with a bcc(001) structure of iron or cobalt, with the result that a high MR ratio occurs. The Bloch state here means that an electron belongs to a specific band, and particularly, the Δ1 Bloch state means that an electron belongs to a band having isotropic symmetry (a band called Δ1 in the field of the science of metal materials).

The fourth MR element of this invention is such that in view of the above-described fact, in the second or third MR element, a ferromagnetic material of a bcc(001) structure is used as the material for the magnetization pinned layer or the magnetization free layer, whereby mainly electrons in the Δ1 Bloch state in the ferromagnetic material carry a current of the MR element, with the result that a large MR ratio is obtained by a substantially high spin polarization rate in the Δ1 Bloch state.

(Use of Magnetization Pinned Layer of bcc(001) Structure and Interposition of Ultrathin Metal Layer in an Interface)

The fifth MR element of this invention is such that in the above-described second to fourth MR elements, a ferromagnetic material of a bcc(001) structure is used in the magnetization pinned layer formed on the first surface of the MgO(001) layer, a metal portion of each in the micropores of the MgO(001) layer is formed from a ferromagnetic material of a bcc(001) structure, and an ultrathin nonmagnetic metal layer having a thickness of not more than about 3.0 nanometers is interposed between the MgO(001) layer and the magnetization free layer. By interposing an ultrathin nonmagnetic metal layer, the flatness between the MgO(001) layer and the magnetization free layer is improved and a high MR ratio can be obtained in the thinner MgO(001) layer. Furthermore, the use of a bcc(001) structure in the metal portion in the micropores may enable the spin filter effect to come into play with a higher efficiency, with the result that the MR ratio increases further.

(Use of Magnetization Pinned Layer and Magnetization Free Layer, Both Having bcc(001) Structure, and Interposition of Ultrathin Metal Layer in an Interface)

The sixth MR element of this invention is such that in the above-described second to fourth MR elements, a ferromagnetic material of a bcc(001) structure is used in the magnetization pinned layer and the magnetization free layer that are present, respectively, on the first surface and the second surface of the MgO(001) layer, the metal portion of each of the micropores of the MgO(001) layer is also formed from a ferromagnetic material of a bcc(001) structure, and an ultrathin nonmagnetic metal layer having a thickness of not more than about 3.0 nanometers is interposed between the MgO(001) layer and the magnetization free layer. By forming both of the magnetization pinned layer and the magnetization free layer from a ferromagnetic material of a bcc(001) structure in comparison with the above-described fifth MR element, the spin filter effect in the MgO(001) layer increases further and the MR ratio increases further.

(Designation of Materials for Magnetization Pinned Layer and Magnetization Free Layer)

The seventh MR element of this invention is such that in the above-described second to sixth MR elements, a ferromagnetic alloy containing iron, cobalt and nickel as main components is used as the ferromagnetic material of a bcc(001) structure.

(Another Designation of Materials for Magnetization Pinned Layer and Magnetization Free Layer)

The eighth MR element of this invention is such that in the above-described seventh MR element, there is used a ferromagnetic alloy of cobalt-iron-boron, cobalt-iron-nickel-boron and the like, which is an amorphous structure in a state immediately after thin-film fabrication and becomes crystallized to form a bcc(001) structure by post annealing.

(Application to Magnetic Sensors)

The magnetic sensor is a magnetic sensor that reads out recorded information by detecting a leakage magnetic field of a recording medium, which comprises a CPP type GMR element. The magnetization free layer performs magnetization reversal due to a leakage magnetic field of the recording medium, whereby the direction of the magnetic field of the recording medium is detected as a change in electric resistance of the sensor.

The CPP type GMR element having an ultrathin MgO barrier layer may obtain an MR element of a simple construction that has a low resistance and a high MR ratio without the need to use a complex, multilayer structure.

The use of the above-described MR element as a magnetic sensor enables a magnetic head adaptable to a substantially high magnetic recording density to be provided.

### BRIEF DESCRIPTION OF THE DRAWINGS

FIG. 1 is a diagram that shows an example of the construction of an MR element provided with an ultrathin MgO(001) layer in an intermediate layer according to an exemplary embodiment.

FIG. 2 is a diagram that shows an example of the construction of an MR element provided with an ultrathin MgO(001) layer in an intermediate layer and a material having a bcc(001) single-crystal structure in a magnetization pinned layer, according to an exemplary embodiment.

FIG. 3 is a diagram that shows an example of the construction of an MR element provided with an ultrathin MgO(001) layer in an intermediate layer and a material having a bcc(001) single-crystal structure in a magnetization pinned layer and a magnetization free layer, according to an exemplary embodiment.

FIG. 4 is a diagram that shows an example of the construction of an MR element provided with an ultrathin MgO(001) layer in an intermediate layer and a material having a bcc(001) single-crystal structure in a magnetization pinned layer, with an ultrathin nonmagnetic metal layer sandwiched between a magnetization free layer and the ultrathin MgO(001) layer, according to an exemplary embodiment.

FIG. 5 is a diagram that shows an example of the construction of an MR element provided with an ultrathin MgO(001) layer in an intermediate layer and a material having a bcc(001) single-crystal structure in a magnetization pinned layer and a magnetization free layer, with an ultrathin nonmagnetic metal layer sandwiched between a magnetization free layer and the ultrathin MgO(001) layer, according to an exemplary embodiment.

FIGS. 6(A) and 6(B) are diagrams that show a band structure of single-crystal Fe, according to an exemplary embodiment.

FIGS. 7(A), 7(B), 7(C), 7(D), 7(E), 7(F), and 7(G) are diagrams that show the manufacturing process of an MR element according to an exemplary embodiment.

FIG. 8 is a diagram that shows the construction of a sample used in the exemplary embodiment.

FIG. 9 is a graph that shows the relationship between the thickness of an ultrathin MgO layer and the RA value, according to an exemplary embodiment.

FIG. 10 is a graph that shows the relationship between the thickness of an ultrathin MgO layer and the MR ratio, according to an exemplary embodiment.

FIGS. 11(A) and 11(B) are graphs that show MR characteristics in low-resistance samples, according to an exemplary embodiment.

FIGS. 12(A) and 12(B) are graphs that show resistance values and temperature dependency of the MR ratio in low-resistance samples, according to an exemplary embodiment.

FIG. 13 is a scanning tunnel microscope image of an MgO(001) oriented layer having a thickness equivalent to three atomic layers, which was caused to grow on an Fe(001) plane, according to an exemplary embodiment.

### DETAILED DESCRIPTION OF THE EXEMPLARY EMBODIMENTS

MR elements in exemplary embodiments of the present invention will be described below with reference to the drawings.

### First Exemplary Embodiment

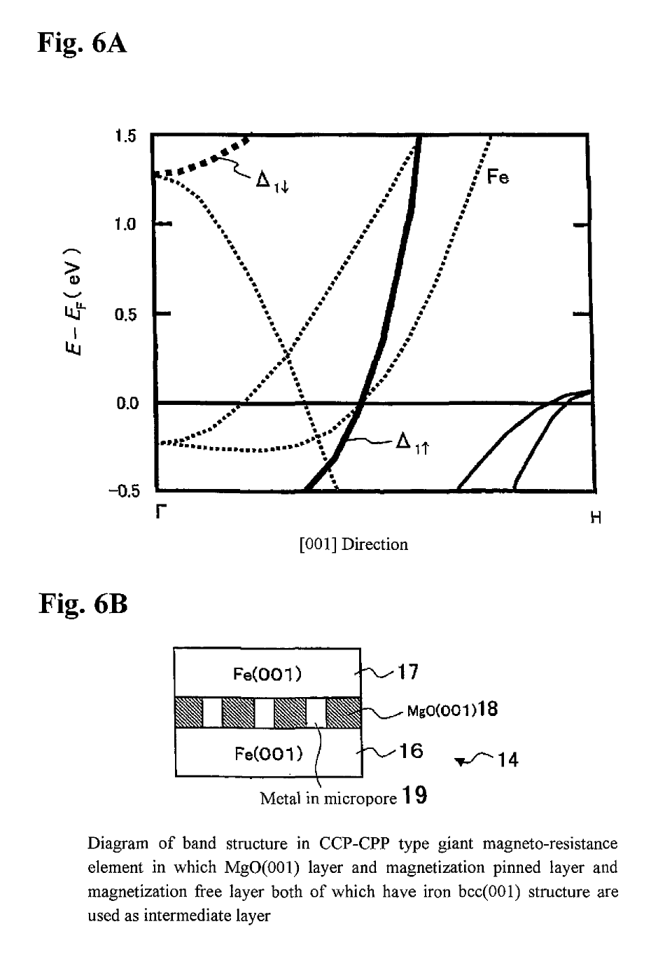

With reference to FIG. 6 to FIG. 12 and Table 1, the exemplary embodiments will be described. First, the present inventors' conception, experimental techniques and experimental results will be described. The inventors studied the spin filter effect by a single-crystal barrier, which is known in an MR element as a TMR element using an MgO barrier, and conceived causing the current confining effect to come into play by using an ultrathin single-crystal barrier, which is an MgO barrier whose thickness is reduced to a limit as the intermediate layer.

First, a description will be given of an increase in MR by the current confining effect. In a CPP-GMR element, a related art technique involves confining a current path by interposing an ultrathin oxide layer in an interface between an intermediate layer and a magnetization pinned layer (or a magnetization free layer), thereby to improve the MR ratio (refer to, for example, H. Fukuzawa et al., IEEE-Mag. Vol. 40 (2004), pp. 2236). The MR ratio may be improved because the current path through the intermediate layer is confined by micropores in the ultrathin oxide layer, and the proportions of a current flowing through the magnetization pinned layer and the intermediate layer and of a current flowing through the intermediate layer and the magnetization free layer increase, such that the effect of the parasitic resistance of an electrode layer decreases relatively. However, in the related art methods that involve using an ultrathin oxide film, the effect on an improvement in MR in a CPP-GMR element was on the order of 5% at most.

On the other hand, in general, in a barrier made of a single-crystal material (hereinafter called a single-crystal barrier), the transmission coefficient of electrons has different values depending on the crystal orientations and electronic bands. A high MR ratio is realized if electrons of a certain electronic band with a high spin polarization rate (i.e., an electronic band in which the proportions of an upward spin and a downward spin are remarkably unbalanced) are caused to be selectively transmitted. Causing only a current having a unidirectional spin to flow selectively by utilizing the electronic properties of a material like this is called the spin filter effect.

An increase in MR by various kinds of single-crystal barriers has hitherto been searched and it has been shown by theoretical research that among others, a TMR element of an Fe/MgO/Fe structure in which iron having a (001) oriented single-crystal structure (hereinafter called Fe(001)) is used in a magnetization free layer and a magnetization pinned layer has substantially a large MR ratio. Prior to the experiment, the inventors have demonstrated that in the above-described TMR element formed from a (001) oriented single crystal (hereinafter called an Fe/MgO/Fe-TMR element), an MR ratio as high as three times or more that of a conventional TMR element using an aluminum oxide barrier occurs (refer to, for example, a group of papers on MgO-TMR elements having high MR ratios: 1) S. Yuasa et al., Nature Mater. Vol. 3 (2004), pp. 868; 2) S. Yuasa et al., Appl. Phys. Lett. Vol. 87 (2005), pp. 222508.; 3) S. S. Parkin et al., Nature Mater. Vol. 3 (2004), pp. 862; and 4) D. Djayaprawira et al., Appl. Phys. Lett. Vol. 86 (2005), pp. 092502).

With reference to FIGS. 6(A) and 6(B), a description will be given of the spin filter effect in an Fe/MgO/Fe-TMR element. FIG. 6(A) is a diagram that shows electronic bands of single-crystal Fe. In FIG. 6(A), the two lines indicated by heavy dotted and solid lines are the Δ1 band of Fe, and electrons belonging to this band are said to be in the Δ1 Bloch state. There are two bands of one electron according to the direction of a spin, and the Δ1 band has a point of intersection only with a band of an upward spin (Δ1↑) at the Fermi surface (E=E_{F}=0 eV) and does not have a point of intersection with a band of a downward spin (Δ1↓). That there is no point of intersection means that the electronic state does not exist at the Fermi surface, and hence this shows that the Δ1 band of Fe has been completely polarized. That is, it might be assumed that by combining a single crystal of Fe and a barrier through which only electrons of a (001) crystal orientation pass (for example, an MgO (001) barrier), it is possible to cause only electrons of the Δ1↑ band to pass, with the result that a substantially high polarization rate (i.e., a high MR ratio that has hitherto been incapable of being predicted) can be realized. The effect that causes only electrons with a spin of a prescribed direction to pass like this is called the spin filter effect.

By using the ultrahigh vacuum molecular beam epitaxy method (hereinafter called MBE method), the present inventors realized huge MR ratios of not less than 180% in an elaborated single-crystal Fe/MgO/Fe-TMR element that is controlled in terms of atomic accuracy. (Refer to a paper in the group of papers on MgO-TMR elements having high MR ratios: 1) S. Yuasa et al., Nature Mater. Vol. 3 (2004), pp. 868.).

Next, details of the experiment conducted by the inventors will be described. An MR thin film having a high-quality, single-crystal structure whose crystal orientation aligned with (001) direction was made and fabricated into a sub-micrometer-size CCP-CPP type MR element by use of a microfabrication technique, and the characteristics of the CCP-CPP type MR element were evaluated. The MR thin film used here refers to a multilayer film in which, as the structure of elements 14 shown in FIG. 6(B), each of Fe(001) 16, MgO(001) 18 and Fe(001) 17 is formed from the three layers of a magnetization free layer, an ultrathin MgO layer (an intermediate layer) and a magnetization pinned layer. The CCP-CPP type M element is characterized in that micropores are present in the MgO(001) 18 and in that a metal 19 is present in the micropores.

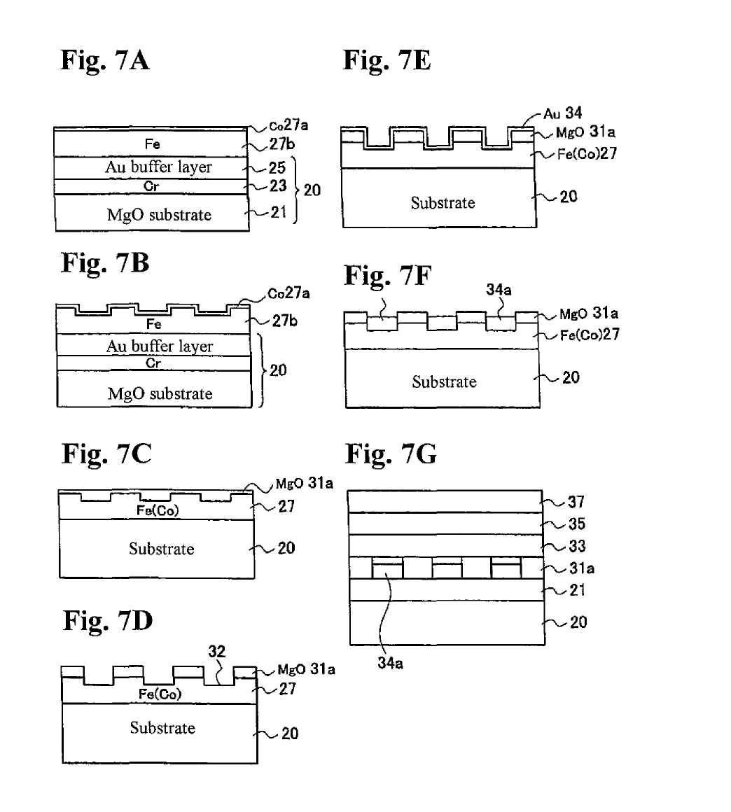

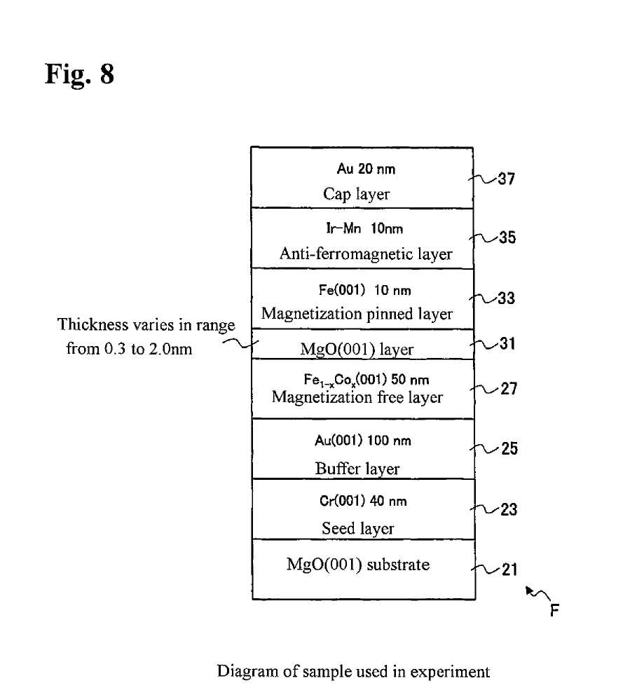

The manufacturing process of an MR element in this exemplary embodiment will be described below with reference to the drawings. FIGS. 7(A) to 7(D) are diagrams that show the manufacturing process of the MR element shown in FIG. 8. FIGS. 7(E) and 7(F) are diagrams that show examples of a method of putting a dissimilar metal into the micropores.

First, chromium 23 as a seed layer and gold 25 as a buffer layer are deposited on a cleaned single-crystal MgO(001) substrate 21 (refer to FIG. 7(A)). Subsequently, an Fe(001) single crystal (a magnetization free layer in this embodiment) 27b is deposited, for example, by the MBE method at room temperature and in an ultrahigh vacuum (2×10⁻⁸ Pa). Although in the figure, a Co(001) single crystal 27a is deposited on the Fe(001) single crystal 27b, the Co(001) single crystal 27a is arbitrarily used. Hereinafter the layers up to the gold buffer layer are collectively referred to as a substrate 20.

Subsequently, annealing treatment is performed at a temperature that enables the surface of the Fe(Co) layer 27 (27a or a combination of 27a and 27b) deposited in the above-described steps to be planarized at an atomic level, for example, at 350° C. However, all of the surface of the Fe(Co) layer 27 is not planarized by this annealing treatment and a terrace structure as shown in FIG. 7(B) having a size of several tens of nanometers to several hundreds of nanometers or so is formed. The formation of a terrace structure has been confirmed from experiments of surface observation by an STM (a scanning tunnel microscope).

Next, as shown in FIG. 7(C), an ultrathin MgO(001) layer 31a is deposited on the planarized Fe(Co) layer 27, for example, by the MBE method at room temperature and in an ultrahigh vacuum. On that occasion, because of a difference of size between MgO molecules and iron atoms (the former is larger), portions having a nonuniform thickness of an MgO(001) layer 31a are formed on the boundaries of the iron terrace. When the film thickness of the MgO(001) layer 31a is as small as not more than a thickness equivalent to three atomic layers, the MgO(001) layer 31a comes to a discontinuous (cut) state in the vicinity of the boundaries of the terrace and micropores 32 are naturally formed. Furthermore, the structure of FIG. 7(C) is again subjected to annealing treatment at 300° C. The MgO in the MgO(001) layer 31a moves due to the annealing, and as shown in FIG. 7(D), the micropores 32 are naturally formed in Fe(Co) layer 27 of a lower layer.

When a dissimilar metal (gold is used here) is put into the micropores, the following step is performed further.

Next, as shown in FIG. 7(E), gold layer 34 is deposited thinly on the structure of FIG. 7(D). Because the amount of the gold layer 34 is small, a continuous layer could not be formed in the plane.

Subsequently, in the structure of FIG. 7(E), the gold atoms in the gold layer 34 moves to places of lower potential (that is, places where the gold atoms are readily adsorbed) by performing annealing treatment again at 300° C. and, therefore, it is possible to form a structure shown in FIG. 7(F) in which the gold 34a is filled into the micropores 32.

In the above-described structure, it is also possible to form a similar structure by causing the gold to evaporate in a state heated to 300° C. from the state of FIG. 7(D).

After the fabrication of the structure of FIG. 7(D) (the structure of FIG. 7(F) when a dissimilar metal is put into the micropores), as shown in FIG. 7(G), a magnetization pinned layer 33 by an Fe(001) single crystal, an iridium-manganese alloy anti-ferromagnetic layer 35, and a gold cap layer 37 are sequentially formed by the MBE method at room temperature and in an ultrahigh vacuum, whereby the structure shown in FIG. 8 below can be realized.

As a method of putting another metal into the micropores formed in the ultrathin MgO(001) layer 31, it is possible to utilize a difference in surface energy between the MgO surface of this metal and the surface in the micropores (in the above-described embodiment, the surface of the Fe(Co) layer 27). For instance, in the case of the above-described example, the surface energy is lower when gold atoms are present on an iron surface than when gold atoms are present on the MgO(001) surface. Because gold atoms have high mobility at relatively low temperatures (300° C. or so), it is possible to ensure that gold is filled into the micropores 32 by performing annealing at 300° C. or so after the evaporation of a substantially small amount of gold (for example, an amount corresponding to a 0.1 atomic layer or so) or by performing evaporation under heating at 300° C. or so.

FIG. 8 is a diagram that shows an example of the construction F of an MR element used as a sample in the experiment. As shown in FIG. 8, upon a single-crystal MgO substrate 21 having a (001) crystal orientation there were deposited by the ultrahigh vacuum MBE method a seed layer 23 (chromium: 40 nm), a buffer layer 25 (gold: 100 nm), a magnetization free layer 27 (iron: about 50 nm or iron: about 50 nm plus cobalt; about 0.6 nm), an ultrathin MgO(001) layer 31 (the thickness varies from about 0.3 to about 2.0 nm) and a magnetization pinned layer 33 (iron: about 10 nm) so that the crystal orientations of each of the layers were aligned with the (001) direction. Subsequently, an anti-ferromagnetic layer 35 (iridium-manganese alloy: 10 nm) and a cap layer 37 (gold: 20 nm) were deposited by the sputtering method.

Subsequently, the above-described multilayer film with the structure F thus obtained was fabricated to form a micro CPP type MR element having a sub-micrometer-size cross-sectional area by a combination of the electron beam lithography and the argon ion milling. The depth of etching by the argon ion milling is up to a level where the ultrathin MgO(001) layer 31 is exceeded from the cap layer 37 (a level several nanometers deep into the magnetization free layer 27). The island-like region thus fabricated has two sizes, 120 nm×220 nm and 220×420 nm. For these sizes, after the etching by the argon ion milling, actually fabricated microjunctions were observed under an electron microscope and the size of the junctions was actually evaluated. For the MR element thus fabricated, the element resistance was measured by the four-terminal method and its resistance values of only the CPP portion were evaluated.

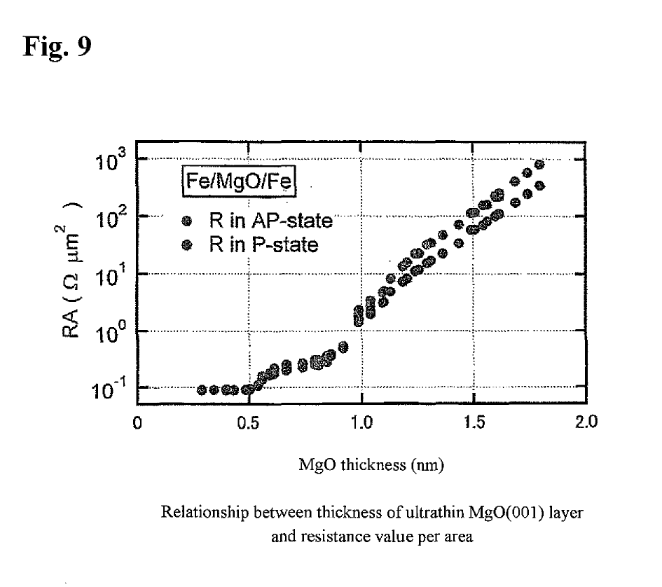

FIG. 9 shows the relation of the RA value to the film thickness of an ultrathin MgO(001) layer. The data of FIG. 9 relates to RA values of the MR elements having a cross-sectional area of 220 nm×420 nm when the M thin-film portion is formed from Fe/MgO/Fe of a (001) oriented single crystal. In a range where the film thickness of the ultrathin MgO(001) layer exceeds 1.0 nm, the RA value increases exponentially, which indirectly demonstrates that in this region, the ultrathin MgO(001) layer functions as a tunnel barrier. On the other hand, in the range where the film thickness is below 1.0 nm, the RA values are lower than values obtained by performing extrapolation from values exceeding the range of 1.0 nm. This suggests that in the range where the film thickness is below 1.0 nm, the ultrathin MgO(001) layer does not sufficiently function as a tunnel barrier. However, it was observed that in the vicinity of a film thickness of 0.6 nm, the RA values increase again.

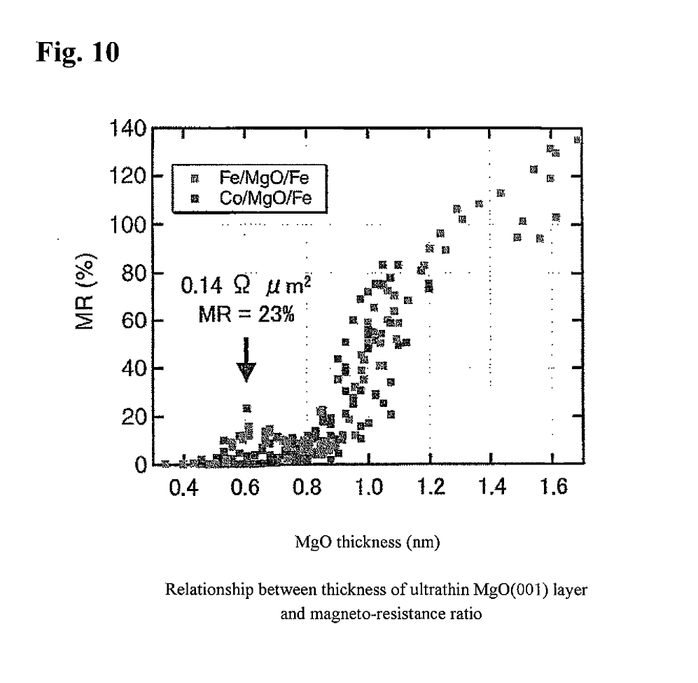

FIG. 10 is a graph that shows the relationship between the thickness of an ultrathin MgO(001) layer and the MR ratio with regard to the fabricated M element. The sample used here is an MR element having a cross-sectional area of 120×220 nm, which is made of Fe(or Co)/MgO/Fe of a (001) oriented single crystal. In the range where the thickness of the ultra-thin MgO(001) layer exceeds 1.0 nm, IR elements having MR ratios of not less than 60% are obtained. On the other hand, in the range where the thickness of the ultrathin MgO(001) layer is below 1.0 nm, the MR ratio decreases abruptly and the magnetization-field curve also becomes irregular. However, where the thickness of the ultrathin MgO(001) layer is in the vicinity of 0.6 nm, the MR ratio increases again and elements having an MR ratio exceeding 20% are obtained. In particular, in the element indicated by an arrow in FIG. 10, good characteristics were obtained when the film thickness of the ultrathin MgO(001) layer was 0.6 nm. That is, the RA value was 0.14 Ω/square micrometer and the MR ratio at room temperature was 23%.

In a CCP type MR element having such an ultrathin MgO(001) layer as an intermediate layer, whether the conduction properties are tunnel-like ones or metallic ones may be important from a practical view point.

There are two kinds of MR elements depending on the material for an intermediate layer. In one kind, an insulator is used as the intermediate layer and electrons conduct by tunnel conduction. This is the TMR (tunnel magneto-resistance) element. In this element, the current-voltage characteristics become nonlinear and current increases exponentially when voltage is applied to the element. The resistance value decreases with increasing temperature. The other kind is an element in which a nonmagnetic metal is used as the intermediate layer and electrons conduct by normal metal conduction. In particular, an MR element having a perpendicular-to-plane structure is called the CPP-GMR element. In this element, the current-voltage characteristics are linear (Ohm's Law) and the resistance value increases with increasing temperature.

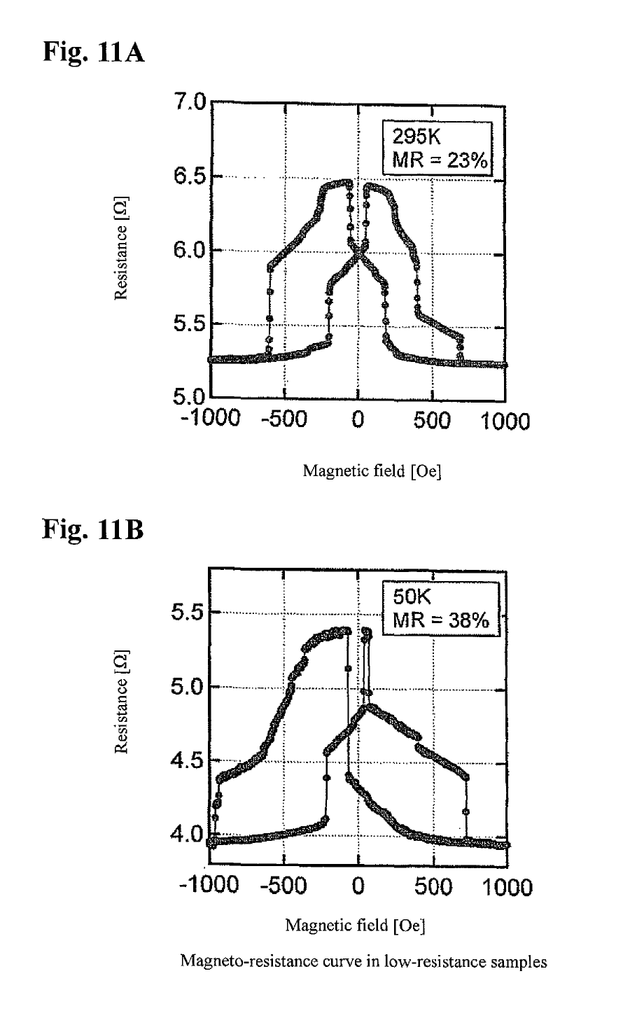

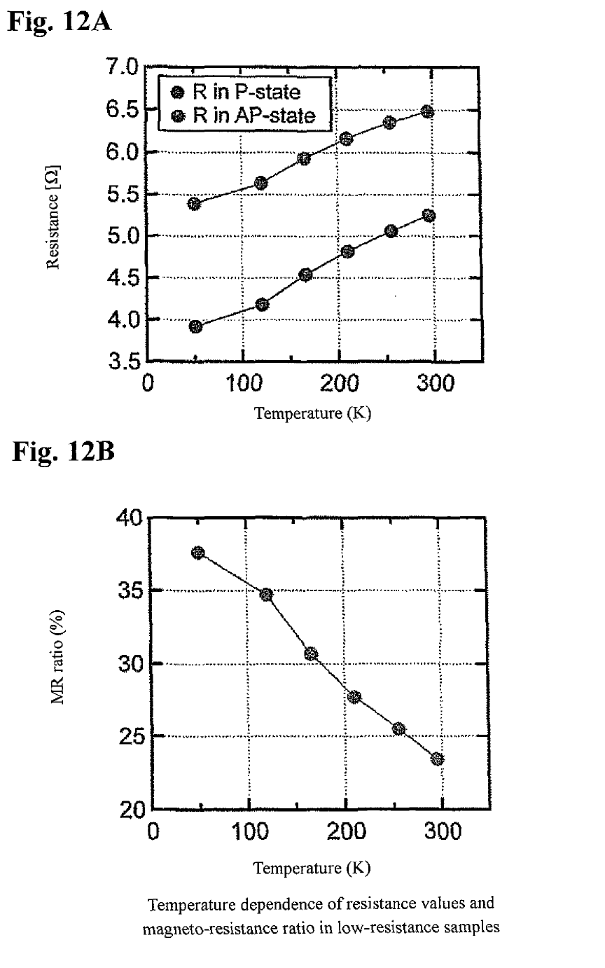

To ascertain which type of conduction occurs in this present element, the MR curve, resistance value and MR ratio of the element indicated by an arrow in FIG. 10 were measured by changing temperature. The results are shown in FIGS. 11(A) and 11(B) and FIGS. 12(A) and 12(B). FIG. 11(A) shows measurement results of MR curves at 295 K, and FIG. 11(B) shows measurement results of MR curves at about 50 K. The MR effect in this element occurs not only at temperatures in the vicinity of room temperature, but also at low temperatures, and the MR ratio increases from 23% to 38%. Furthermore, changes in resistance value occurring when the temperature is changed from about 295 K to about 50 K are shown in FIG. 12(A), and changes in M ratio are shown in FIG. 12(B). The resistance value decreases substantially uniformly with decreasing temperature in both of a high-resistance state (the directions of magnetization of the magnetization pinned layer and the magnetization free layer are antiparallel to each other) and a low-resistance state (the directions of magnetization of the magnetization pinned layer and the magnetization free layer are parallel to each other).

Although the MR ratio increases with decreasing temperature, this is due to the fact that a difference of the resistance between a high-resistance state and a low-resistance state varies little while the resistance valve decreases with decreasing temperature. These characteristics are the features of a CPP-GMR element of a metal material. That is, this shows that in this element the ultrathin MgO(001) layer functions as an intermediate layer having metallic conduction properties, and not as a tunnel barrier.

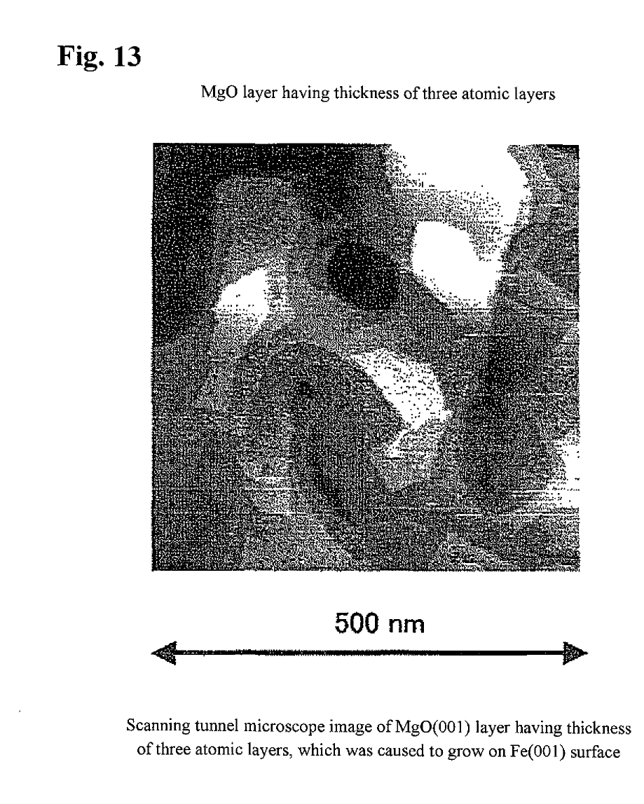

Furthermore, to ascertain that an ultrathin MgO(001) layer having a thickness in the vicinity of 0.6 nanometers shows metallic conduction, the ultrathin Mg(001) layer on single-crystal Fe(001) surface was observed by a scanning tunnel microscope (hereinafter called SEM). FIG. 13 is a SEM image of an ultrathin MgO(001) layer having a thickness of three atomic layers formed on the single-crystal Fe(001) surface, the ultrathin MgO(001) layer being fabricated by use of the same apparatus used in forming the MR thin film used in the experiment. In FIG. 13, the white areas are those where the electric potential is high (i.e., areas where current does not flow easily) and the black areas are those where the electric potential is low (i.e., areas where current flows easily). FIG. 13 shows an image of a region of about 500 nm square, and it is clearly shown that areas where current does not flow easily and areas where current flows easily have a periodic structure. Hereinafter these areas where current flows easily are called micropores. The current-voltage characteristics in the micropores were measured, and it became apparent that the current-voltage characteristics have a good linear relationship. On the other hand, the current-voltage characteristics in the areas where current does not flow easily were of the tunnel type. Thus, the micropores provide a metallic contact, and in the ultrathin MgO(001) layer, the current confining effect occurs naturally.

TABLE 1

| RA (Ω · μm²) | MR (%) at RT |
|---|---|
| 0.96 | 60 |
| 0.78 | 46 |
| 0.60 | 32 |
| 0.20 | 18 |
| 0.14 | 23 |

### A Summary of RA Values per Area and MR Ratios at Room Temperature Obtained in the Experiment in MR Elements in Which an Ultrathin MgO(001) Layer is Used as an Intermediate Layer

Table 1 provides a summary of RA values and MR ratios in CPP type MR elements having a (001) oriented single-crystal Fe(or Co)/MgO/Fe structure obtained in the experiment. In Table 1, an element with an RA value of 0.96 Ω/square micrometer has an ultrathin MgO(001) layer of 1.0 nm and an element with an RA value of 0.14 Ω/square micrometer has an ultrathin MgO(001) layer of 0.6 nm.

As described above, on the basis of the above-described experiment, it was possible to realize a CCP-CPP type MR element having low resistance (RA value: not more than 1 Ω/square micrometer) and a high MR ratio (not less than 20%).

In an element utilizing tunnel conduction, when the current flowing through the element is increased, the resistance further decreases where the temperature has risen and the current is concentrated on the barrier that is thinnest. In general, this element is vulnerable to overcurrent. On the other hand, in an element utilizing metallic conduction, when the temperature rises, the resistance in portions where the temperature has risen increases, and naturally the current becomes uniformly distributed. For this reason, this element has resistance against heat. Therefore, in applications where a considerably large bias current is caused to flow constantly, such as the read-head of a hard disk, the element of metallic conduction type may be advantageous, but is not required to be advantageous.

### Second Exemplary Embodiment

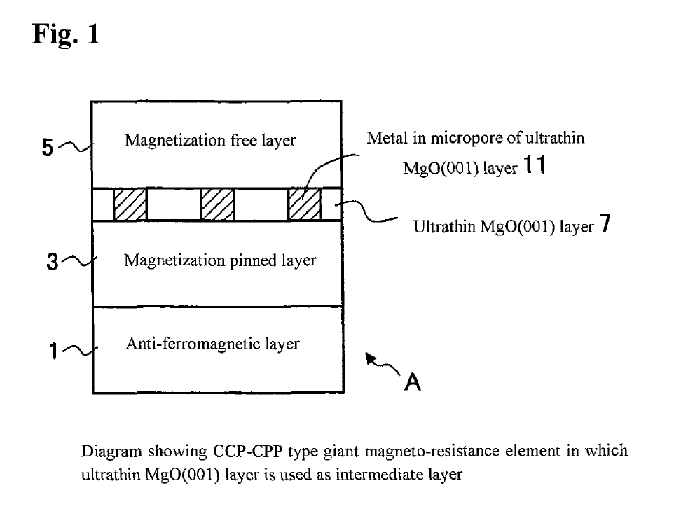

Next, the second exemplary embodiment will be described with reference to the drawings. FIG. 1 is a diagram that shows the construction of a CCP-CPP type MR element in the second exemplary embodiment. An MR element A has, as the intermediate layer, an ultrathin MgO(001) layer 7 having micropores with a thickness of not more than 1.0 nanometer. The MgO(001) layer used here refers to a magnesium oxide layer having a single-crystal structure whose crystal plane is oriented in the (001) direction (or a polycrystalline structure that is preferentially oriented in the (001) direction). When such a structure is used, the current confining effect is caused to come into play due to a metal 11 present in the micropores in the MgO(001) layer 7 and, therefore, the MR ratio increases. The structure of a spin valve type MR element in which an anti-ferromagnetic layer 1 is caused to be in close vicinity of a magnetization pinned layer 3 is adopted. However, it is not always necessary that the anti-ferromagnetic layer 1 be provided, and a material having a large coercive force may be used as the magnetization pinned layer 3.

Furthermore, for the magnetization pinned layer, it is also possible to use a multilayer film having a structure called a synthetic anti-ferromagnetic layer. Incidentally, a synthetic anti-ferromagnetic layer refers to a multilayer film that sandwiches two ferromagnetic layers having substantially the same magnitude of magnetization via an antiparallel bonding film and magnetically bonds the two ferromagnetic layers in an antiparallel direction. As an example of a synthetic anti-ferromagnetic layer, there is an iron-cobalt alloy/ruthenium thin film/iron-cobalt alloy. Although examples of a material for an antiparallel bonding film include alloys made of one kind or two kinds of substances selected from the group consisting of ruthenium, iridium, rhodium, rhenium and chromium, it is desirable to use a ruthenium thin film (film thickness: about 0.5 to 1.0 nm).

In the MR element of the second embodiment, the thickness of the MgO(001) layer, which is the intermediate film, may be about 0.5 to about 0.7 nm. As the experiment results described in the first exemplary embodiment, when the intermediate layer is a single-crystal MgO(001) layer, it is possible to ensure that in the vicinity of a thickness of 0.6 nm, low area resistance (0.14 Ω/square micrometer) and a high MR ratio (not less than 20%) are compatible with each other. Furthermore, in an MR element of the second exemplary embodiment, it is preferred that the diameter of the micropores present in the MgO(001) layer, which is the intermediate layer, be not more than about 50 nm. If the diameter of the micropores is not less than about 50 nm, i.e., sizes that cannot be neglected compared to a micro MR element (fore example, the size of an element required of a high-density magnetic head is on the order of several hundreds of nanometers square), then there is a fear that variations among elements might become great.

As described above, the thickness of 0.6 nm corresponds to the thickness of three atomic layers of the MgO(001) layer. In order to fabricate such a thin layer, it is necessary to planarize the under layer to an atomic layer level. Annealing at an appropriate temperature may be adopted as a method of planarization. In actuality, however, the whole under layer is not planarized by annealing treatment in an ultrahigh vacuum and it is planarized only to a certain macroscopic size (for example, in the shape of a terrace). In the case of an Fe(001) single crystal, it is known that a surface of an Fe(001) single crystal is planarized in a terrace-like shape having a size of several tens to several hundreds of nanometers. When an ultrathin MgO layer is formed on such a structure, portions where the MgO(001) layer becomes discontinuous (thin portion) are formed on the boundaries of the terrace (steps) because of difference in size of the iron molecule and the MgO molecule, with the result that micropores are formed. That is, when MgO(001) layer having a thickness of three atomic layers is formed, part of the MgO(001) layer provides holes and other part becomes thick (4 layers or more).

Accordingly, the structure of the under layer is considered for making regular micropores of not more than about 50 nm in the ultrathin MgO(001) layer. The under layer (magnetization free layer) is an Fe(001) single crystal formed by the MBE method. From an observation experiment using a SEM it has been ascertained that when an Fe(001) single crystal is formed on a gold buffer layer, it obtains a periodic terrace structure of about 50 nm to about 100 nm. Therefore, an Fe(001) single crystal is suitable for making an ultrathin MgO(001) layer having periodic micropores.

### Third Exemplary Embodiment

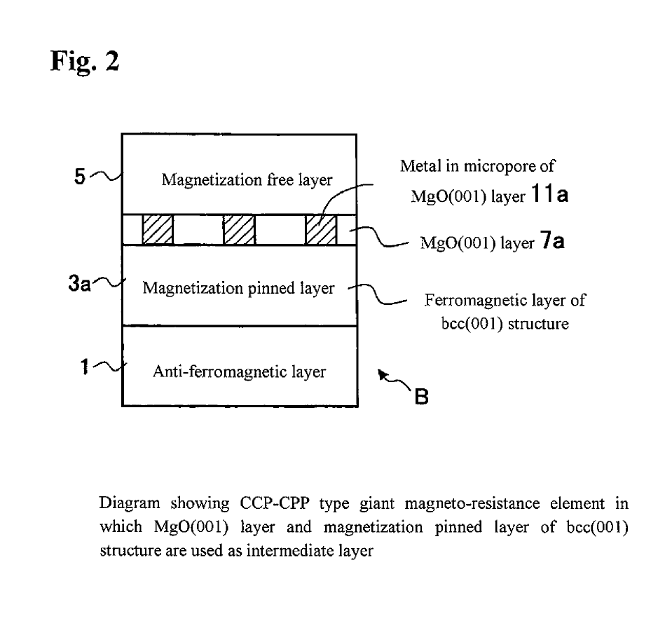

Next, the third exemplary embodiment will be described. FIG. 2 is a diagram that shows an example of the construction of a CCP-CPP type MR element in the third exemplary embodiment. This MR element in the third exemplary embodiment is such that in the MR element A of the second exemplary embodiment, a ferromagnetic material having a bcc (001) structure is used in a magnetization pinned layer 3a. Other features of the construction are the same as shown in FIG. 1. By adopting the above-described structure, the crystallizability and flatness of the MgO (001) layer are further improved and the MR resistance ratio increases further.

### Fourth Exemplary Embodiment

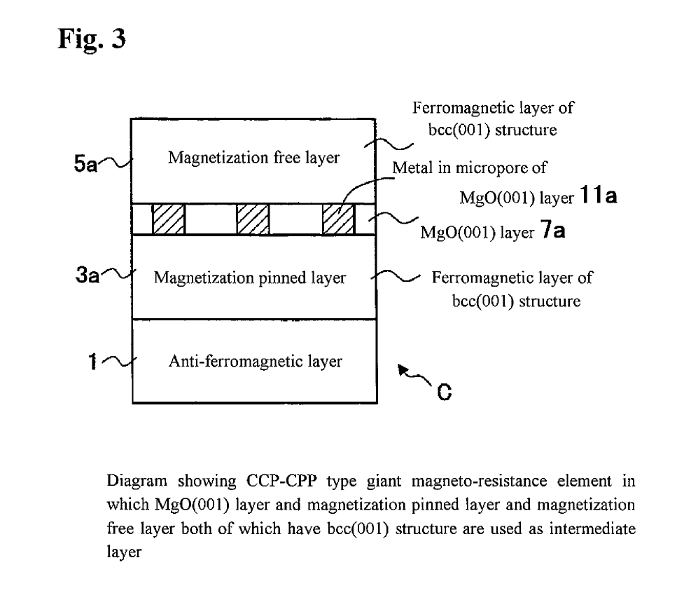

Next, the fourth exemplary embodiment will be described. FIG. 3 is a diagram that shows an example of the construction of a CCP-CPP type MR element in the fourth exemplary embodiment. This MR element C is such that in the MR element of the third embodiment shown in FIG. 2, a ferromagnetic material having a bcc(001) structure is used in both of a magnetization pinned layer 3a and a magnetization free layer 5a. By adopting this structure, the crystallizability and flatness of the MgO(001) layer 7a are further improved and the MR resistance increases further.

### Fifth Exemplary Embodiment

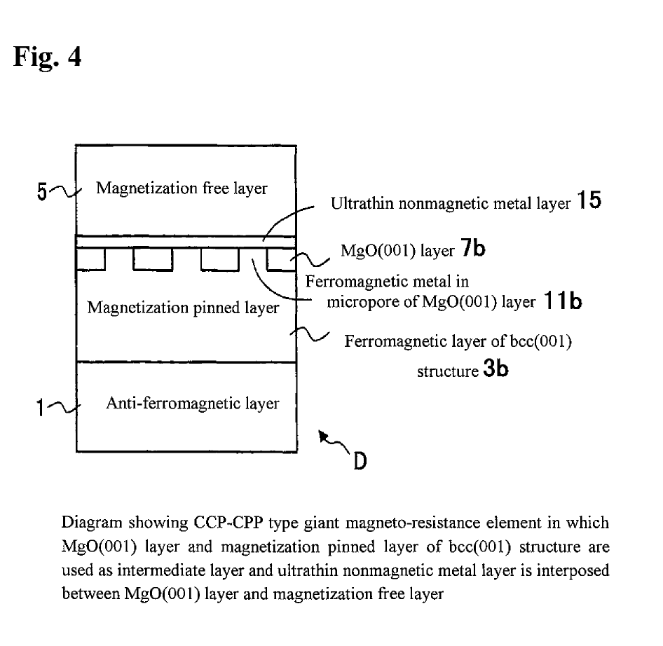

Next, the fifth exemplary embodiment will be described. FIG. 4 is a diagram that shows an example of the construction of a CCP-CPP type MR element in the fifth exemplary embodiment. This MR element D is such that in the MR element B of the third exemplary embodiment, an ultrathin nonmagnetic layer 15 having a thickness of not more than about 3.0 nm as a buffer layer is interposed in an interface between a magnetization free layer 5 and an ultrathin MgO(001) layer 7b which is the intermediate layer. The buffer layer 15 is formed to improve the flatness at the interface and it is possible to use nonmagnetic metals, such as magnesium, tantalum, gold, copper and alloys of these metals (for example, copper nitride).

### Sixth Exemplary Embodiment

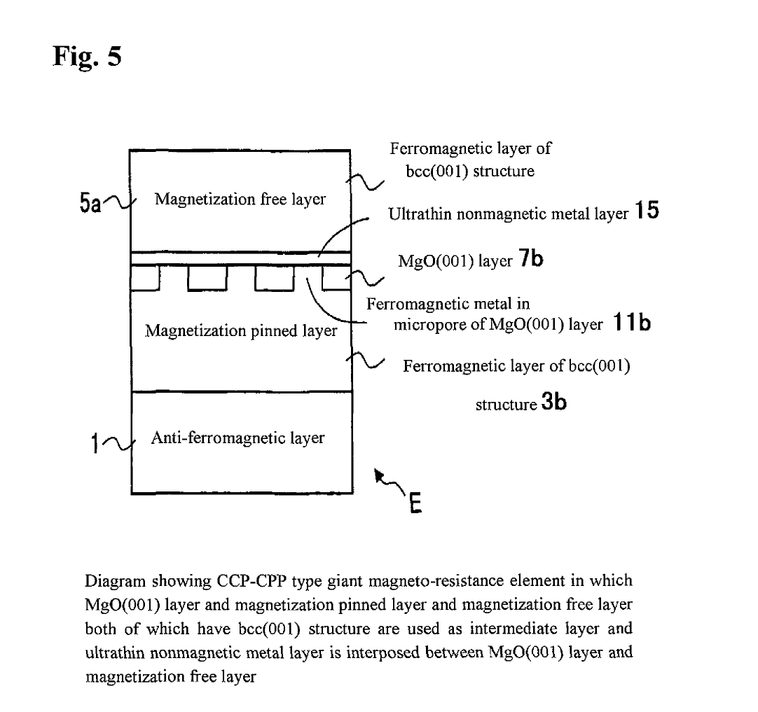

Next, the sixth exemplary embodiment will be described. FIG. 5 is a diagram that shows an example of the construction of a CCP-CPP type MR element in the sixth exemplary embodiment. This MR element E in the sixth exemplary embodiment is such that in the MR element C of the fourth exemplary embodiment, an ultrathin nonmagnetic layer 15 having a thickness of not more than about 3.0 nm as a buffer layer is interposed in an interface between a magnetization free layer 5a and an ultrathin MgO(001) layer 7b which is the intermediate layer. The buffer layer 15 is formed to improve the flatness at the interface and it is possible to use nonmagnetic metals, such as magnesium, tantalum, gold, copper and alloys of these metals (for example, copper nitride).

The effectiveness of the technique for interposing the ultrathin nonmagnetic layer in the interface in the CCP-CPP type MR elements of the above-described fifth and sixth exemplary embodiments has been demonstrated in the point of reducing the area resistance of the elements while maintaining high MR ratios in an MgO-TMR element. For example, by interposing a magnesium thin film in an interface between an MgO layer and a magnetization pinned layer, an M ratio of 138% was realized in an MgO-TMR element having an RA value of 2.4 Ω/square micrometer (refer to “A Paper on MgO-TMR Elements Having Low RA Values”; K. Tsunekawa et al., Appl. Phys. Lett. 87, 072503 (2005)). In contrast to this, also in the CCP-CPP type MR element having an ultrathin MgO layer, it is possible to increase the MR ratio in a lower-resistance region by interposing a buffer layer in the interface between the ultrathin MgO layer and the magnetization free layer.

### Seventh Exemplary Embodiment

Next, a CCP-CPP type MR element in the seventh exemplary embodiment will be described. The CCP-CPP type MR element in the seventh exemplary embodiment is such that a material containing iron, cobalt and nickel as main components is used as the material for the ferromagnetic material of a bcc(001) structure used in the MR elements of the second to fifth exemplary embodiments. Concretely, iron, cobalt, cobalt-iron alloys, cobalt-iron-boron alloys, cobalt-iron-boron-nickel alloys, and alloys obtained by adding molybdenum, vanadium, chromium, silicon and aluminum to these metals and alloys, or two or more kinds of ferromagnetic materials of a bcc(001) structure can be fabricated into objects that are stacked in lamellar form (laminated structures of thin films).

As already described, it is thought that a cause of the huge MR in a TMR in which an MgO(001) barrier layer is used as the intermediate layer may be the spin filter effect that comes into play when the MgO(001) barrier layer is combined with a ferromagnetic material of a bcc(001) structure. For iron, cobalt, cobalt-iron alloys, cobalt-iron-boron alloys and cobalt-iron-boron-nickel alloys among the above-described materials, it has already been ascertained that these metals and alloys are ferromagnetic materials of a bcc(001) structure, and that huge MR ratios (of not less than 100% at room temperature) are caused to occur in a TMR element in which an MgO barrier layer is used as the intermediate layer. Also in the CCP-CPP type MR element in which an ultrathin MgO layer is used as the intermediate layer, the Δ1 Bloch state having a high polarization rate due to the bcc(001) structure may be one of the causes of the high MR ratio. Therefore, the above-described group of materials is desirable as materials for the magnetization free layer and magnetization pinned layer in the MR element of the exemplary embodiment.

### Eighth Exemplary Embodiment

Next, the eighth exemplary embodiment will be described. The CCP-CPP type MR element of the eighth exemplary embodiment is such that as the ferromagnetic materials of a bcc(O) structure used in the MR elements of the second to fifth exemplary embodiments, there is used a material that has an amorphous structure in a state immediately after thin-film fabrication and becomes crystallized to form a bcc(001) structure by post annealing. Examples of the material include cobalt-iron alloys, cobalt-iron-boron alloys, cobalt-iron-boron-nickel alloys and cobalt-iron-boron-copper alloys.

It has been reported that in related art TMR elements in which an MgO barrier layer is used as the intermediate layer, the MR ratio is substantially sensitive to the crystallizability of the magnetization pinned layer and magnetization free layer. If the magnetization pinned layer and magnetization free layer have a bcc(001) structure, a high MR occurs. However, the MR ratio becomes substantially small if the crystal structure of these layers becomes irregular. The present inventors realized a bcc(001) structure in the magnetization pinned layer and magnetization free layer by fabricating an elaborated single-crystal TMR element that is controlled at an atomic level by using the ultrahigh vacuum MBE method (refer to 1): S. Yuasa et al., Nature Mater. Vol. 3 (2004), pp. 868 in a group of papers on MgO-TMR elements having high M ratios). However, this method may not be suitable for mass production. On the other hand, D. Djayaprawira et al. fabricated a TMR element in which an MgO barrier layer is used as the intermediate layer by the sputtering method and caused the structure of the magnetization pinned layer and magnetization free layer to be crystallized from an amorphous structure into a bcc(001) structure by performing post annealing (annealing after film forming), with the result that they obtained an MR ratio equivalent to that of an element fabricated by the ultrahigh vacuum MBE method (refer to 4): D. Djayaprawira et al., Appl. Phys. Lett. Vol. 86 (2005), pp. 092502 in a group of papers on MgO-TMR elements having high MR ratios). This method is highly evaluated as a technique indispensable for the mass production of TMR elements in which an MgO barrier film is used as the intermediate layer.

Also in the MR element of the exemplary embodiment, that it is possible to be able to fabricate an element by the above-described method (the magnetization pinned element and magnetization free element are fabricated by the sputtering method and caused to be crystallized into a bcc(001) structure by post annealing) is indispensable for mass production. For cobalt-iron alloys, cobalt-iron-boron alloys and cobalt-iron-boron-nickel alloys among the above-described materials, in a TMR element in which an MgO barrier layer is used as the intermediate layer, high MR ratios (not less than 100% at room temperature) are realized by the sputtering film-fabrication and the post annealing. It might be thought that also in the MR element of the exemplary embodiment, in which an ultrathin MgO(001) layer is used as the intermediate layer, high MR ratios occur by using the above-described materials as the materials for the magnetization pinned layer and magnetization free layer and adopting the sputtering film-fabrication and the post annealing.

### Ninth Exemplary Embodiment

Next, the ninth exemplary embodiment will be described. In the CCP-CPP type MR elements described in the above first to eighth exemplary embodiments, it is possible to realize low resistance and high MR ratios compared to those of conventional MR elements. For this reason, by using these MR elements, it becomes possible to provide a magnetic sensor capable of higher-accuracy, higher-density sensing. As described in connection with the first exemplary embodiment, in an experiment on a CPP type MR element made of single-crystal Fe/ultrathin MgO/Fe oriented in the (001) orientation, it is possible to realize an RA value of 0.14 Ω/square micrometer and an MR ratio of 23%. These values sufficiently exceed RA values of not more than 1 Ωl/square micrometer and MR ratios of not less than 20%, which are the specifications required of the magnetic head of a hard disk with a high recording density of about 500 Gbytes/square inch.

Incidentally, in applications to a magnetic head for reading out a high-density hard disk, it is required to lower the area resistance value rather than to raise the MR ratio. For example, area resistance of 4 Ω/square micrometer is required for 200 Gbytes/square inch, and 1 Ω/square micrometer is required for about 500 Gbytes/square inch. On the assumption that the above-described scaling holds for recording density, area resistance of 0.25 Ω/square micrometer is required for 1 Tbytes/square inch. Therefore, it is possible to cope with a recording density of 1 Tbytes/square inch by using the element of this exemplary embodiment.

As described above, it is apparent that by using the CPP type MR elements of this exemplary embodiment, it is possible to provide a magnetic head adaptable to a high recording density hard disk.

As described above, according to the CCP-CPP type GMR element having an ultrathin MgO barrier layer as described in each of the exemplary embodiments, it is possible to obtain an MR element having low resistance (RA value of not more than 1 Ω/square micrometer) and high MR values (not less than 20%) without using a complex multilayer structure.

By using this CCP-CPP type GMR element as a magnetic sensor, it becomes possible to provide an MR head adaptable to magnetic recording densities of not less than about 500 Gbytes/square inch.

The MR element of this exemplary embodiment is characterized by a substantially low impedance. Examples of the low-impedance MR element include a low-noise magnetic sensor and an output element in a magnetic theoretical circuit.

The exemplary embodiments can be applied to a magnetic sensor

What is claimed is:

1. A CCP (current confined path)-CPP (current-perpendicular-to-plane) type giant magneto-resistance element comprising:
a magnetization pinned layer;
an intermediate layer; and
a magnetization free layer, wherein a single-crystal or polycrystalline magnesium oxide (MgO(001)) layer having a thickness of not more than about 1.0 nanometer and whose crystal axis is preferentially oriented in the (001) direction, is used as the intermediate layer.

2. The magneto-resistance element according to claim 1, wherein the thickness of the MgO(001) layer is in the range of about 0.5 nanometers to about 0.7 nanometers.

3. The magneto-resistance element according to claim 1, wherein the diameter of micropores present in the MgO(001) layer is not more than about 50 nanometers.

4. The magneto-resistance element according to claim 1, wherein a ferromagnetic material of a bcc(001) structure comprising at least one of a single-crystal and a polycrystalline ferromagnetic metal and a ferromagnetic metal alloy of a bcc (body-centered cubic) structure whose crystal axis is preferentially oriented in the (001) direction is in a magnetization pinned layer formed on a first surface of the MgO(001) layer.

5. The magneto-resistance element according to claim 1, wherein a ferromagnetic material of a bcc(001) structure is used in the magnetization pinned layer formed on the first surface of the MgO(001) layer and a magnetization free layer formed on a second surface thereof.

6. The magneto-resistance element according to claim 4, wherein electrons substantially in the Δ1 Bloch state in the ferromagnetic material of a bcc(001) structure carry a current, and a substantially large magneto-resistance ratio is obtained by a substantially high spin polarization rate in the Δ1 Bloch state.

7. The magneto-resistance element according to claim 1, wherein a ferromagnetic material of a bcc(001) structure is used in the magnetization pinned layer formed on the first surface of the MgO(001) layer, a metal portion of each of the micropores of the MgO(001) layer is formed from a ferromagnetic material of a bcc(001) structure, and an ultrathin nonmagnetic metal layer having a thickness of not more than about 3.0 nanometers is interposed between the MgO(001) layer and the magnetization free layer.

8. The magneto-resistance element according to claim 1, wherein a ferromagnetic material of a bcc(001) structure is used in the magnetization pinned layer formed on the first surface of the MgO(001) layer and the magnetization free layer formed on the second surface thereof the metal portion of each in the micropores of the MgO(001) layer is also formed from a ferromagnetic material of a bcc(001) structure, and an ultrathin nonmagnetic metal layer having a thickness of not more than about 3.0 nanometers is interposed between the MgO(001) layer and the magnetization free layer.

9. The magneto-resistance element according to claim 4, wherein a ferromagnetic alloy containing iron, cobalt and nickel as main components is used as the ferromagnetic material of a bcc(001) structure.

10. The magneto-resistance element according to claim 4, wherein, as the ferromagnetic material of a bcc(001) structure, a ferromagnetic alloy of iron-cobalt-boron, iron-cobalt-nickel-boron is used, which is an amorphous structure in a state immediately after thin-film fabrication and becomes crystallized to form a bcc(001) structure by post annealing.

11. A magnetic head that reads out record information by detecting a leakage magnetic field of a recording medium, comprising a CCP-CPP type giant magneto-resistance element according to claim 1, wherein the magnetization free layer performs magnetization reversal due to a leakage magnetic field of the recording medium, whereby the direction of the magnetic field of the recording medium is detected as a change in its electric resistance.

12. A method of manufacturing the magneto-resistance element, comprising:
depositing an MgO thin film on a ferromagnetic material layer of a bcc(001) structure which is a magnetization free layer or a magnetization pinned layer in which a terrace structure is formed, whereby the MgO thin film comes into a discontinuous state in a vicinity of boundaries of the terrace structure, and micropores are formed in the discontinuous portions;
depositing a metal thin layer on the MgO thin film, whereby the metal thin film is filled into the micropores; and
forming a ferromagnetic material layer of a bcc(001) structure, which is a magnetization pinned layer or a magnetization free layer after the filling step.

13. The method of manufacturing the magneto-resistance element according to claim 12, wherein the terrace structure is formed by performing annealing treatment after the ferromagnetic material layer of a bcc (001) structure is formed.

14. The method of manufacturing the magneto-resistance element according to claim 12, wherein after the metal thin film is filled into the micropores by depositing the metal thin film, the filling is promoted by performing annealing treatment.

15. The method of manufacturing the magneto-resistance element according to claim 12, wherein when the metal thin film is filled into the micropores by depositing the metal thin film, the filling is promoted by performing annealing treatment substantially simultaneously with the film deposition.
